(19) United States
(12) Patent Application Publication
(10) Pub. No.: US 2025/0378716 A1
(43) Pub. Date: Dec. 11, 2025

(54) SYSTEMS AND METHODS FOR USING A VEHICLE ACOUSTIC SIGNATURE TO DETERMINE A SPEED ASSOCIATED WITH A VEHICLE

(71) Applicant: THE BOEING COMPANY, Arlington, VA (US)

(72) Inventor: Gladston Joseph, Woodinville, WA (US)

(21) Appl. No.: 18/739,816

(22) Filed: Jun. 11, 2024

(51) Int. Cl. G07C 5/02; G06N 20/00; H04R 1/40; H04R 3/00

(52) U.S. Cl. CPC G07C 5/02; G06N 20/00; H04R 1/406; H04R 3/005; H04R 2499/13

(57) ABSTRACT

A vehicle includes a body, a first microphone positioned in an interior of the body and configured to receive sound generated by movement of a first surface of the body relative to a fluid, and one or more processors coupled to the first microphone. The one or more processors are configured to receive an audio signal corresponding to sound received by the first microphone, analyze the audio signal to determine a first speed associated with the vehicle based on an acoustic signature associated with the first surface, and based at least on the speed of the vehicle, cause performance of one or more vehicle management operations.

### FIELD OF THE DISCLOSURE

The subject disclosure is generally related to systems and methods for using a vehicle acoustic signature to determine a speed associated with a vehicle.

### BACKGROUND

With increasing air traffic, safety and reliability of aircraft operation becomes correspondingly important. One way aircraft operators ensure safe and reliable operation is through various types of sensors on the aircraft. For example, an airspeed sensor can provide information about the speed at which an aircraft is moving relative to an oncoming air mass. This data is used for the proper functioning of flight control systems, especially during critical phases of flight such as takeoff, landing, and maneuvers.

Aircraft sensors should be accurate, and redundant sources of accurate information should be available to aircrew. Inaccurate speed readings can lead to confusion for flight crews and potentially dangerous flight situations. Redundant sensors act as a fail-safe mechanism, allow flight crews and/or the flight control system to cross-check data from multiple sources, and allow identification of vehicle speed discrepancies or sensor failures quickly. This redundancy enhances the overall reliability of the aircraft systems and increases safety margins, particularly in scenarios where accurate aircraft speed and angle of attack information is used to facilitate stable flight.

Furthermore, redundant sensors contribute to the resilience of an aircraft in the face of various environmental factors. Adverse weather conditions, such as icing or volcanic ash can affect the performance of sensors, leading to unreliable readings. Having multiple installed sensors ensures that the aircraft can maintain accurate flight data even in challenging conditions. It is desirable to have redundant sensors that enable determination of one or more flight conditions (e.g., speed, angle of attack, etc.) for an aircraft, where at least two or three of the redundant sensors operate based on different principles of operation (e.g., a first sensor that operates based on one or more measured pressures and a second sensor that operates based on an acoustic signature).

### SUMMARY

In a particular implementation, a method includes receiving, at a computing device, from a first microphone positioned in an interior of a vehicle an audio signal corresponding to sound received by the first microphone. The sound is generated by movement of a first surface of the vehicle relative to a fluid. The method includes analyzing, by the computing device, the audio signal to determine a first speed associated with the vehicle based on an acoustic signature associated with the first surface. The method also includes, based at least on the first speed, causing, by the computing device, performance of one or more vehicle management operations.

In another particular implementation, a non-transitory computer-readable medium includes instructions that, when executed by one or more processors, cause the one or more processors to receive, from a first microphone positioned in an interior of a vehicle an audio signal corresponding to sound received by the first microphone. The sound is generated by movement of a first surface of the vehicle passing relative to a fluid. The instructions, when executed by the one or more processors, cause the one or more processors to analyze the audio signal to determine a speed associated with the vehicle based on an acoustic signature associated with the first surface. The instructions, when executed by the one or more processors, also cause the one or more processors to cause, based at least on the speed of the vehicle, performance of one or more vehicle management operations.

In another particular implementation, a vehicle includes a body and a first microphone positioned in an interior of the body. The microphone is configured to receive sound generated by movement of a first surface of the body relative to a fluid. The vehicle also includes one or more processors coupled to the first microphone. The one or more processors are configured to receive an audio signal corresponding to sound received by the first microphone, analyze the audio signal to determine a first speed associated with the vehicle based on an acoustic signature associated with the first surface, and based at least on the speed of the vehicle, cause performance of one or more vehicle management operations.

### BRIEF DESCRIPTION OF THE DRAWINGS

FIG. 1 depicts an example system for using a vehicle acoustic signature to determine a speed associated with a vehicle, in accordance with some examples of the subject disclosure.

FIG. 2 illustrates an example spectrogram of a frequency intensity level of each of a plurality of frequencies associated with an audio signal versus a time at which the plurality of frequencies were received by a computing device, in accordance with some examples of the subject disclosure.

FIG. 3 is a flow chart of an example method for using a vehicle acoustic signature to determine a speed associated with a vehicle, in accordance with some examples of the subject disclosure.

FIG. 4 is a flowchart of an example method illustrating a life cycle of an aircraft that includes a system for using a vehicle acoustic signature to determine a speed associated with a vehicle, in accordance with some examples of the subject disclosure.

FIG. 5 illustrates an example aircraft that includes a component for using a vehicle acoustic signature to determine a speed associated with a vehicle, in accordance with some examples of the subject disclosure.

FIG. 6 is a block diagram of a computing environment including a computing device configured to support aspects of computer-implemented methods and computer-executable program instructions (or code), in accordance with some examples of the subject disclosure.

### DETAILED DESCRIPTION

The systems and methods disclosed herein provide a speed sensor capable of determining one or more conditions of use of a vehicle, including a speed associated with the vehicle (e.g., an airstream speed), based on a vehicle acoustic signature. The sensor system may be used in conjunction with other sensors that are able to measure vehicle speed that are based on different principles of operation in order to increase the reliability of monitoring the speed during vehicle use and to be able to determine if an operational problem exists with respect to the speed sensor or one or more of the other sensors. For an automobile, the other sensors may include a speedometer that operates by detection of magnetic pulses to measure speed of the vehicle relative to the surface on which the vehicle travels. For aircraft, the other sensors may include one or more static pressure sensors and one or more stagnation pressure sensors with components (e.g., pitot tubes) located on an exterior of the vehicle to allow measurement of stagnation pressures. The speed of the fluid stream (i.e., air) is directly proportional to the density of the fluid multiplied by a dynamic pressure (i.e., the stagnation pressure less the static pressure). The systems and methods disclosed herein receive an audio signal associated with an acoustic signature of a surface of the vehicle passing through a fluid (e.g., an aircraft traveling through air, an automobile passing through air, a ship traveling through water, etc.). The systems and methods can analyze, by a computing device, the audio signal to determine a speed associated with the vehicle.

A technical advantage of the subject disclosure is (1) the enablement of efficient and reliable sensor operation and (2) detection of sensor problems by comparisons of output from different types of sensors with different principles of operation. For example, a redundant speed sensor for an aircraft implemented within the aircraft using the systems and methods disclosed herein can provide redundant speed information, and the redundant speed information can be compared to output of one or more primary speed sensors that include components (e.g., pitot tubes) positioned in the air stream in order to determine if there are problems associated with speed information of the redundant speed sensor or the output of any of the primary speed sensors. One or more problems associated with operation of the primary sensors (e.g., icing or foreign matter that obstructs a pitot tube) can simultaneously affect each of the primary sensors, but such a problem is unlikely to occur simultaneously with a problem that affects operation of the redundant speed sensor (e.g., electrical failure of one or more components of the redundant speed sensor).

Another technical advantage of the subject disclosure is the enablement of efficient and reliable sensor operation through the use of a speed sensor installed in the interior of a vehicle, thus removing any need to expose a portion of the sensor to the fluid stream being measured. The systems and methods of the subject disclosure can provide both locational dissimilarity (e.g., by being positioned in the interior of a vehicle rather than the exterior of a vehicle), as well as functional dissimilarity (e.g., by providing a speed estimate through predicting a freestream speed without measuring a property of a fluid through which the vehicle is traveling rather than measuring a fluid property—as with a pitot-static system—or measuring a property of the vehicle itself—as with an automobile speedometer measuring a wheel's rotational speed). The systems and methods of the subject disclosure can enable prediction of a vehicle property (e.g., vehicle speed) without directly measuring that vehicle property (e.g., by measuring sound).

The figures and the following description illustrate specific exemplary embodiments. It will be appreciated that those skilled in the art will be able to devise various arrangements that, although not explicitly described or shown herein, embody the principles described herein and are included within the scope of the claims that follow this description. Furthermore, any examples described herein are intended to aid in understanding the principles of the disclosure and are to be construed as being without limitation. As a result, this disclosure is not limited to the specific embodiments or examples described below, but by the claims and their equivalents.

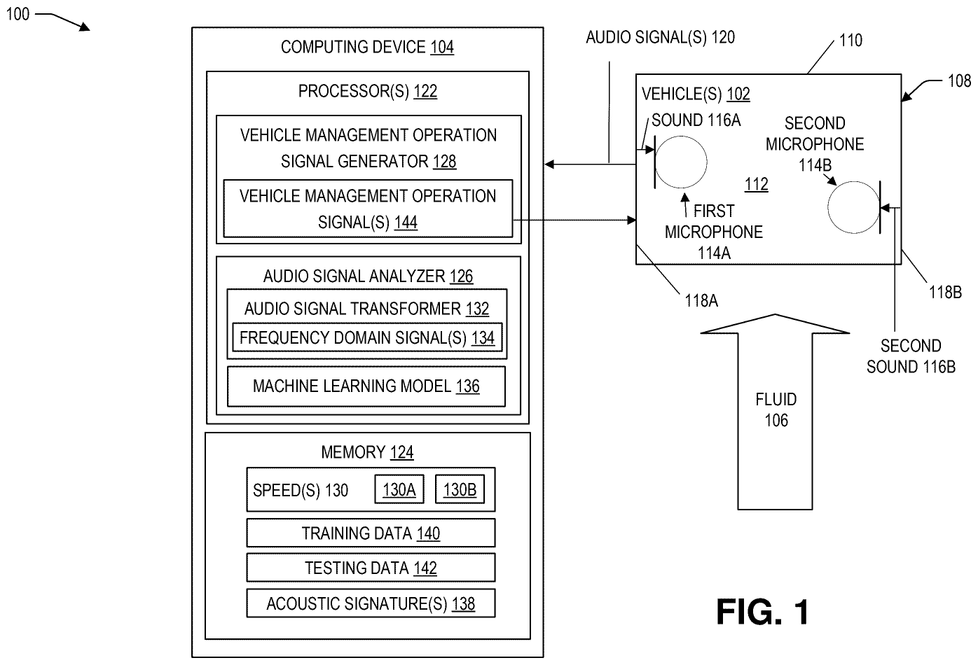

Particular implementations are described herein with reference to the drawings. In the description, common features are designated by common reference numbers throughout the drawings. In some drawings, multiple instances of a particular type of feature are used, and the multiple instances can all be of the same type (e.g., a particular model of the feature), or may include two or more different types (e.g., a first type of the feature and a second type of the feature that is different than the first type but is still identified as the feature). Although these features are physically and/or logically distinct, the same reference number is used for each, and the different instances are distinguished by addition of a letter to the reference number. When the features as a group or a type are referred to herein (e.g., when no particular one of the features is being referenced), the reference number is used without a distinguishing letter. However, when one particular feature of multiple features of the same type is referred to herein, the reference number is used with the distinguishing letter. For example, referring to FIG. 1, multiple speeds are illustrated as having been determined by a computing device 104 and saved in a memory 124. The multiple speeds are associated with reference numbers 130A and 130B. When referring to a particular one of these speeds, such as the first speed 130A, the distinguishing letter “A” is used. However, when referring to any arbitrary one of these speeds or to these speeds as a group, the reference number 130 is used without a distinguishing letter.

As used herein, various terminology is used for the purpose of describing particular implementations only and is not intended to be limiting. For example, the singular forms “a,” “an,” and “the” are intended to include the plural forms as well, unless the context clearly indicates otherwise. Further, some features described herein are singular in some implementations and plural in other implementations. To illustrate, FIG. 1 depicts a computing device 104 including one or more processors (“processor(s)” 122 in FIG. 1), which indicates that in some implementations the computing device 104 includes a single processor 122 and in other implementations the computing device 104 includes multiple processors 122. For ease of reference herein, such features are generally introduced as “one or more” features and are subsequently referred to in the singular or optional plural (as indicated by “(s)”) unless aspects related to multiple of the features are being described.

The terms “comprise,” “comprises,” and “comprising” are used interchangeably with “include,” “includes,” or “including.” Additionally, the term “wherein” is used interchangeably with the term “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

As used herein, “generating,” “calculating,” “using,” “selecting,” “accessing,” and “determining” are interchangeable unless context indicates otherwise. For example, “generating,” “calculating,” or “determining” a parameter (or a signal) can refer to actively generating, calculating, or determining the parameter (or the signal) or can refer to using, selecting, or accessing the parameter (or signal) that is already generated, such as by another component or device. As used herein, “coupled” can include “communicatively coupled,” “electrically coupled,” or “physically coupled,” and can also (or alternatively) include any combinations thereof. Two devices (or components) can be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled can be included in the same device or in different devices and can be connected via electronics, one or more connectors, or inductive coupling, as illustrative, non-limiting examples. In some implementations, two devices (or components) that are communicatively coupled, such as in electrical communication, can send and receive electrical signals (digital signals or analog signals) directly or indirectly, such as via one or more wires, buses, networks, etc. As used herein, “directly coupled” is used to describe two devices that are coupled (e.g., communicatively coupled, electrically coupled, or physically coupled) without intervening components.

FIG. 1 depicts an example system 100 for using a vehicle acoustic signature to determine a speed associated with a vehicle 102, in accordance with some examples of the subject disclosure. In some implementations, the system 100 includes a computing device 104 coupled to the vehicle 102.

In some implementations, the vehicle 102 can include, correspond to, or be included within any appropriate vehicle (e.g., a land vehicle, a water vehicle, an aircraft, or a combination thereof) moving relative to a fluid 106. For example, the vehicle 102 can include, correspond to, or be included within an aircraft (e.g., an airplane, an unmanned aerial vehicle, etc.) and the fluid 106 is air, within an automobile or boat and the fluid 106 is air, or within a watercraft (e.g., a boat, a submersible, etc.) and the fluid 106 is water. As another example, the vehicle 102 can include, correspond to, or be included within a spacecraft and the fluid 106 can be a portion of an atmosphere of an astronomical object.

The vehicle 102 can include a body 108 having an exterior surface 110 and an interior 112 (e.g., one or more compartments within the body 108). The vehicle 102 includes one or more microphone(s) 114 positioned in the interior 112 of the vehicle 102. Each of the microphone(s) 114 is configured to receive sound 116 generated by movement of a surface 118 associated with the microphone 114 relative to the fluid 106. When the vehicle 102 includes multiple microphones 114, the microphones 114 may include a single type of microphone, a single microphone size, multiple types of microphones, multiple microphones sizes, or combinations thereof. A particular surface 118 associated with a particular microphone 114 is a portion of the exterior surface 110 of the vehicle 102. For example, a first surface 118A is associated with a first microphone 114A and a second surface 118B is associated with a second microphone 114B. In some aspects, the first surface 118A is located on a first side of the vehicle 102 and the second surface 118B is located on a second side of the vehicle 102 opposite the first side. For example, the first surface 118A is a portion of a port side exterior surface of an aircraft with reference to a forward travel direction of the aircraft through air, and the second surface 118B is a starboard side exterior surface of the aircraft. In other aspects, the microphones 114A, 114B may be associated with other surfaces 118 corresponding to portions of the exterior surface 110 of the aircraft.

In some implementations, the vehicle 102 includes a first microphone 114A positioned in the interior 112 of the vehicle 102 and configured to receive sound 116A generated by movement of the first surface 118A associated with the first microphone 114A relative to the fluid 106. The vehicle may also include a second microphone 114B positioned in the interior 112 of the vehicle 102 to receive second sound 116B generated by movement of the second surface 118B associated with the second microphone 114B relative to the fluid 106. In some implementations, the vehicle 102 may include only a single microphone 114 (e.g., the first microphone 114A) or one or more additional microphones 114 (e.g., the second microphone 114B or one or more additional microphones 114 positioned in the interior 112 of the vehicle 102 to receive sound 116 generated by movement of other surfaces 118 associated with the one or more additional microphones 114). For example, the one or more additional microphones 114 may include a third microphone associated with a surface corresponding to a top exterior surface of the vehicle 102 and a fourth microphone associated with a surface corresponding to a bottom exterior surface of the vehicle 102, other microphones 114, or combinations thereof.

In some implementations, the vehicle 102 is configured to communicate to the computing device 104 an audio signal(s) 120 corresponding to the sound(s) 116 received by the microphone(s) 114. The audio signal(s) 120 can include data associated with one or more noise elements associated with the surface(s) 118 corresponding to the microphone(s) 114. In some aspects, the content of the audio signal(s) 120 is based at least on a location of the surface(s) 118 on the vehicle 102, skin friction associated with the surface(s) 118, shape of the surface(s) 118, functionality of the microphone(s) 114, the type of the microphone(s) 114, position of the microphone(s) 114 relative to the surface(s) 118, the material of the surface(s) 118, or a combination thereof. For example, the audio signal(s) 120 can include data associated with machinery noise generated by various components of the vehicle 102 (e.g., engine noise), cavitation noise, hydrodynamic noise, aerodynamic noise, etc.

The sounds 116 generated by the surface(s) 118 and received by the microphone(s) 114 associated with the surfaces 118 at a particular time can be different. For example, the sound 116A from surface 118A received by the microphone 114A can be different from the sound 116B from surface 118B received by the microphone 114B. As another example, the sound 116 from a first particular surface 118 on a first side of the vehicle 102 received by a first particular microphone 114 can be different from the sound 116 from a second particular surface 118 also on the first side of the vehicle 102 received by a second particular microphone 114. Sensitivity of the system 100 described herein can be calibrated for relatively greater sensitivity for a particular surface 118 with a small area and relatively less sensitivity for a particular surface 118 with a large area. The size of the area of the surface 118 associated with a microphone 114 may depend on the positioning of the microphone 114 relative to the surface 118 in the interior 112 of the vehicle 102.

In some implementations, the computing device 104 is configured to receive audio signal(s) 120 from the microphone(s) 114. The computing device 104 includes one or more processors 122 coupled to a memory 124. The memory 124 may include computer-readable, non-transitory storage media (e.g., one or more computer-readable storage devices). The processor(s) 122 can include an audio signal analyzer 126, a vehicle management operation signal generator 128, other components, or some combination thereof, implemented by execution of instructions by the processor(s) 122.

In some implementations, the audio signal analyzer 126 can be configured to analyze the audio signal(s) 120 received from the microphone(s) 114 to determine one or more speeds 130 associated with the vehicle 102. In the implementation depicted in FIG. 1, the speeds 130 include a first speed 130A associated with the first audio signal of the audio signal(s) 120 corresponding to the sound 116A received by the first microphone 114A and a second speed 130B associated with the second audio signal of the audio signal(s) corresponding to the second sound 116B received by the second microphone 114B. In implementations with additional microphones, an additional speed 130 can be determined for each additional microphone 114. As described further below, the audio signal analyzer 126 can be configured to analyze the first audio signal of the audio signal(s) 120 received from the first microphone 114A based at least on the sound 116A received by the first microphone 114A due to movement of the first surface 118A of the vehicle 102 relative to the fluid 106 to determine the first speed 130A. The audio signal analyzer 126 can also be configured to analyze audio signal(s) 120 received from additional microphones 114 based at least on the sounds received by the additional microphones 114 due to movement of corresponding surfaces 118 relative to the fluid 106 to determine additional speed(s) 130.

In a particular aspect, the computing device 104 is configured to detect differences in speeds 130 associated with different sides of the vehicle 102. For example, the first surface 118A is located on a first side of the vehicle 102, the second surface 118B is location on a second side of the vehicle 102 opposite the first side, and the processor(s) 122 are configured to determine a side slip measurement of the vehicle based on the first speed 130A and the second speed 130B. In a particular configuration, the vehicle management operation signal generator 128 can generate a side slip alert signal when the side slip measurement exceeds a threshold.

In another particular aspect of the above, the first surface 118A is located on a bottom of the vehicle 102, the second surface 118B is located on a top of the vehicle 102 opposite the bottom, and the processor(s) 122 are configured to determine an angle of attack measurement based on the first speed 130A and the second speed 130B. For example, the processor(s) 122 can be configured to measure the angle of attack of the vehicle 104 relative to the fluid 106 by using differential airspeed measured by the microphones 114 placed on the top and bottom of the vehicle.

In some implementations, the audio signal analyzer 126 can be configured to analyze the audio signal(s) 120 and can include an audio signal transformer 132 configured to transform the audio signal(s) 120 to frequency domain signal(s) 134. For example, the audio signal transformer 132 of the audio signal analyzer 126 can be configured to apply a Fourier transform to the audio signal(s) 120 to transform the audio signal(s) 120 to the frequency domain signal(s) 134.

In the same or alternative aspects, the audio signal analyzer 126 can be configured to analyze the audio signal(s) 120, including analyzing the audio signal(s) 120 with a trained machine learning model 136, to determine the speed(s) 130 based on comparisons of the frequency domain signal(s) 134 to acoustic signatures 138 corresponding to surfaces 118 associated with microphones that send the audio signal(s) 120 to the computing device 104. The memory includes a plurality of acoustic features for each surface 118 associated with one of the microphone(s) 114. The acoustic signatures 138 include features that correspond to particular speeds associated with the vehicle 102. In a particular aspect, the trained machine learning model 136 is trained using historical data as training data 140 to generate the acoustic signatures 138. The training data 140 can include data associated with frequency domain transformation(s) of the audio signal(s) 120, historical data associated with the speed of the vehicle 102 determined by a sensor of the vehicle 102 (e.g., one or more traditional speed sensors such as speedometers of land vehicles measuring speed of the vehicle 102 relative to the surface on which the vehicle 102 is traveling, speed sensors utilizing pitot tubes for aircraft, speed determination based on global positioning system (GPS) data, etc.) or some combination thereof. For example, the trained machine learning model 136 can be trained using data associated with a Fourier transform of the audio signal(s) 120 as well as data from another speed sensor of the vehicle 102, inertial systems associated with the vehicle 102, altitude measurements associated with the vehicle 102, engine speed measurements associated with the vehicle 102, throttle setting(s) for the vehicle 102, temperature, etc. to correlate information determined from the frequency domain data with the measured speed data.

In the same or alternative particular aspects, the trained machine learning model 136 can be tested using testing data 142. The testing data 142 can include the same data as the training data 140. For example, the trained machine learning model 136 can be tested using data associated with a Fourier transform(s) of the audio signal(s) 120 as well as data from another speed sensor of the vehicle 102 to correlate the frequency domain data with the measured speed data to determine if output of the trained learning model is sufficiently close to the measured values of the testing data 142. If the machine learning model 136 does not produce output that is sufficiently close to the measured values of the testing data 142, one or more parameters of the machine learning model 136 can be adjusted, or a new machine learning model 136 can be developed, and the resulting machine learning model 136 can be trained using the training data 140 and tested with the testing data 142.

In some implementations, the trained machine learning model 136 is part of the computing device 104. In other implementations, the trained machine learning model 136 can be separate from the computing device 104. For example, a second computing device can be provided with the training data 140 and the testing data 142, and the second computing device can be configured to generate the trained machine learning model 136. The second computing device can be configured to communicate the acoustic signatures 138 to the computing device 104.

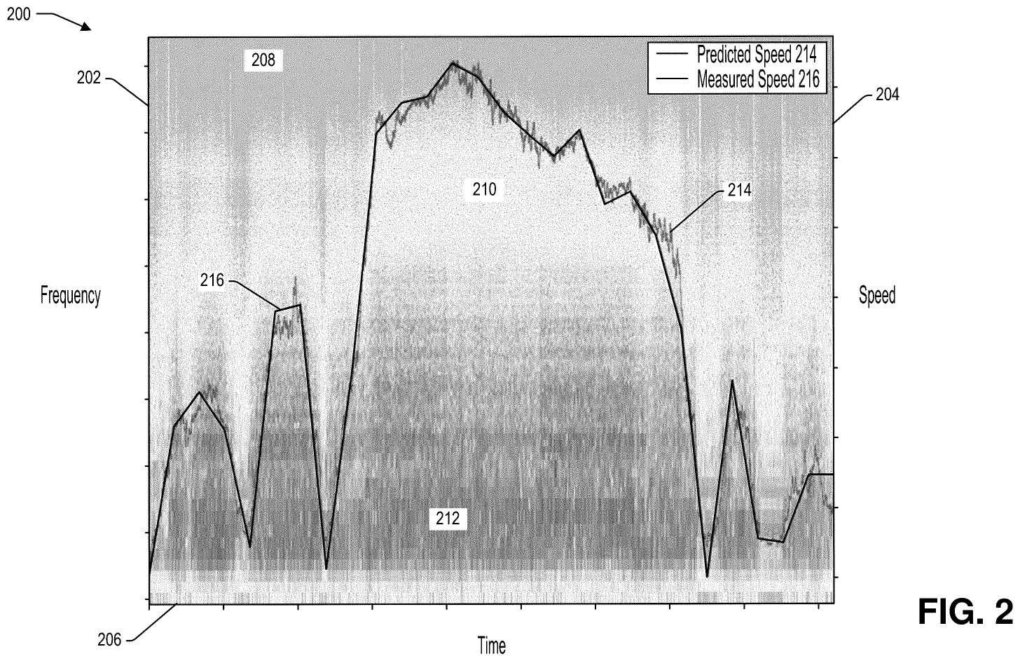

In some implementations, the audio signal analyzer 126 can be configured to obtain information associated with a plurality of frequencies of the audio signal(s) 120, analyze frequency intensity level(s) associated with each of the plurality of frequencies, and, based at least on the frequency intensity level(s) associated with each of the plurality of frequencies, determine the speed(s) 130 of the vehicle 102. For example, as described below with reference to FIG. 2, the audio signal analyzer 126 can be configured to correlate the intensities of various frequencies associated with the audio signal(s) 120 to a particular speed(s) 130 of the vehicle 102 based on comparisons of the intensities to acoustic signatures 138 to provide output of the speed(s) 130. In some aspects, the audio signal analyzer 126 can be configured to analyze a change in a particular frequency intensity to determine whether the change is associated with a change in a particular speed.

In some implementations, the vehicle management operation signal generator 128 can be configured to cause, based at least on the speed(s) 130 of the vehicle 102, performance of one or more vehicle management operations. In some aspects, the vehicle management operation signal generator 128 can be configured to generate one or more vehicle management operation signals 144 for communication to the vehicle 102. Upon receipt of one or more of the vehicle management operation signal(s) 144, the vehicle 102 can be configured to perform the one or more vehicle management operations according to the received signals.

In some aspects, the vehicle management operations can include generating an excessive speed alert signal, generating an insufficient speed alert signal, altering the speed of the vehicle 102, or some combination thereof. For example, the vehicle management operation signal generator 128 can generate one or more vehicle management operations signals 144 for communication to the vehicle 102. The vehicle 102 can be configured to generate an alert that the speed of the vehicle 102 is above an excessive speed threshold (e.g., an excessive speed alert), below an insufficient speed threshold (e.g., an insufficient speed alert), automatically speed or slow the vehicle 102 (e.g., altering the speed of an unmanned aerial vehicle), or some combination thereof.

In operation, the vehicle 102 can include one or more microphones 114 to receive sound 116 associated with one or more surfaces 118 of the vehicle 102. The computing device 104 can be configured to receive audio signals 120 associated with the sound(s) 116 received by the microphone(s) 114. The audio signal analyzer 126 can analyze the audio signal(s) 120 (e.g., by applying Fourier transform(s) to generate the frequency domain signal(s) 134) to determine one or more speeds 130 associated with the vehicle 102 based on comparisons to acoustic signatures 138 associated with the vehicle 102. The audio signal analyzer 126 can be configured to determine the speed(s) 130 by, for example, the use of the machine learning model 136 trained on the training data 140 and tested with the testing data 142. The audio signal analyzer 126 determines the speed(s) 130 by analyzing a frequency intensity level associated with each of a plurality of frequencies of the audio signal(s) 120, as described in more detail below with reference to FIG. 2.

The systems and methods described above can enable use of the vehicle acoustic signatures 138 as a dissimilar source (including as a primary source, a backup source, or both) for determination of one or more speeds 130 associated with the vehicle by achieving the technical benefits described above. For example, the systems and methods provide for a vehicle improvement, a sensor improvement, or both, by enabling a speed sensor to provide a redundant source of speed information from a sensor operating in a dissimilar environment from certain traditional speed sensors. As another example, the systems and methods provide for a vehicle improvement, a sensor improvement, or both, by enabling the use of a speed sensor installed on the interior of a vehicle, thus removing any need to modify the exterior of the vehicle (e.g., for performance reasons, cosmetic reasons, or come combination thereof).

FIG. 2 illustrates an example spectrogram 200 for data from a speed sensor that determines speed based on an acoustic signature. The example spectrogram 200 depicts a frequency (e.g., in Hertz) of each of a plurality of frequencies associated with an audio signal (e.g., the audio signal 120 of FIG. 1 from the microphone 114) generated due to movement of a vehicle (i.e., a car) through air and speeds associated with the vehicle (e.g., in km/s) versus a time (e.g., in seconds) at which the plurality of frequencies were received by a computing device (e.g., the computing device 104 of FIG. 1), in accordance with some examples of the subject disclosure. The example spectrogram 200 includes a first axis 202, a second axis 204, and a third axis 206.

The first axis 202 illustrates a range of frequency values of the received plurality of frequencies, with lower frequencies represented lower on the first axis 202 and higher frequencies represented higher on the first axis 202. In the example spectrogram 200, the frequency intensity level (e.g., the signal strength (e.g., dB)) received by the microphone 114 of the velocity sensor of each of the plurality of frequencies is illustrated by gradient shading, with a lower frequency intensity level 208 represented by light gray shades, with a medium frequency intensity level 210 represented as substantially white shades, and with a higher frequency intensity level 212 represented as dark gray shades. The second axis 204 illustrates the speed of the vehicle (e.g., kilometers per hour), with higher speeds represented higher on the second axis 204. The third axis 206 illustrates a time period over which a plurality of frequencies were received by the computing system, with earlier time represented to the left of the third axis 206 and later time to the right of the third axis 206.

The example spectrogram 200 also illustrates two correlations. A first correlation line illustrates a predicted speed 214 of the vehicle determined using the microphone(s) 114 of FIG. 1, where the predicted speed 214 is based on the speed of the fluid through which the vehicle is traveling relative to the vehicle. A second correlation line illustrates a measured speed 216 of the vehicle using a traditional speed sensor (i.e., global positioning system (“GPS”) data), where the measured speed 216 is based on the speed of the vehicle relative to the Earth. A comparison of the predicted speed 214 to the measured speed 216 shows that there is a relatively close match between the predicted speed 214 of the vehicle and the actual speed 216 of the vehicle, including a relatively close match between the two functionally dissimilar methods of measuring speed of the vehicle.

For the example spectrogram 200, the predicted speed 214 of the vehicle was generated by an audio signal analyzer (e.g., the audio signal analyzer 126 of FIG. 1), where the predicted speed 214 corresponds to a speed determined based on comparison of a frequency domain signal determined from an audio signal provided by microphone of the speed sensor to acoustic signatures associated with particular speeds of the vehicle. For example, the audio signal analyzer 126 of the speed sensor determines the frequency domain signal 134 from the audio signal 120 received from the microphone 114 and provides the frequency domain signal 134 as input to the machine learning model 136. The machine learning model 136 performs comparisons of features of the frequency domain signal to features of acoustic signatures that correspond to particular speeds, determines the speed 130 based on the comparisons, and outputs the speed 130 as the predicted speed 214.

In some implementations, as described above with respect to FIG. 1, the speed(s) 130 of the vehicle 102 can be based on analysis of the audio signal(s) received by the computer device 104 from the microphone(s) 114 positioned in the interior 112 of the vehicle 102 and configured to receive sounds 116 generated by the surface(s) 118 of the vehicle 102 passing through the fluid 106. In the example spectrogram 200 of FIG. 2, the predicted speed 214 was determined by analyzing the audio signal 120 with reference to the acoustic signatures 138 associated with the surface 118 of the vehicle 102. The audio signal analyzer 126 transformed the audio signals 120 to frequency domain signals 134 and provided the frequency domain signals 134 as input to the machine learning model 136. The machine learning model 136 performed comparisons of features of the frequency domain signals 134 to features of acoustic signatures 138 associated with the surface and corresponding to particular speeds of the vehicle, and based on the comparisons, the machine learning model 136 determined the speed 130, and provided the speed 130 as the predicted speed 214. In a particular aspect, the audio signal analyzer 126 can be configured to receive other inputs in addition to the audio signal and use the other inputs when determining the speed(s) 130. For example, for an aircraft the audio signal analyzer 126 can be configured to consider inputs including altitude, engine speed (e.g., revolutions-per-minute, N₁ measurements, etc.), inertial measurement unit readings, sensor input, or combinations thereof, when determining the speed(s) 130. The machine learning model 136 may be trained with historical data including values for the inputs and the machine learning model 136 may receive the inputs as input data when determining the speed(s) 130.

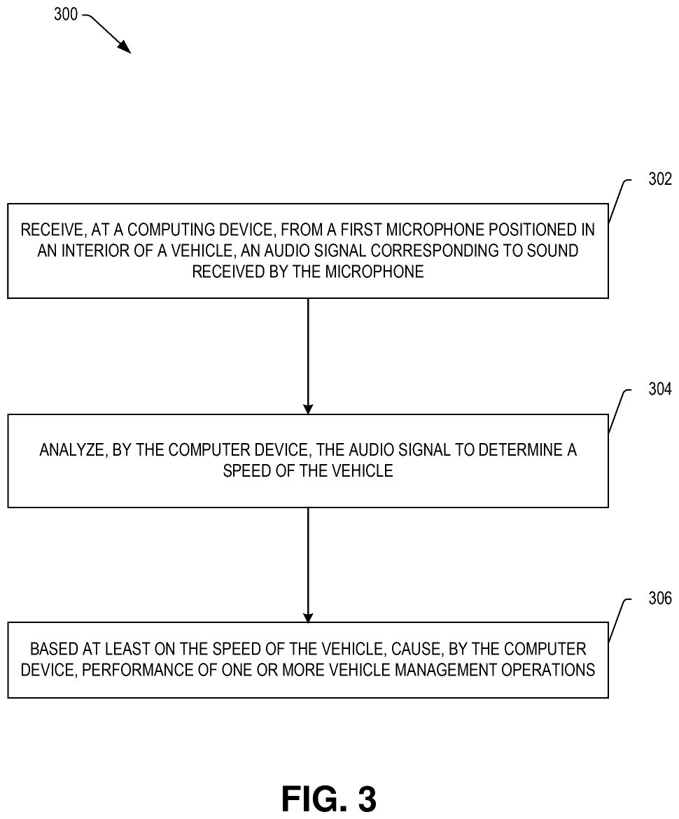

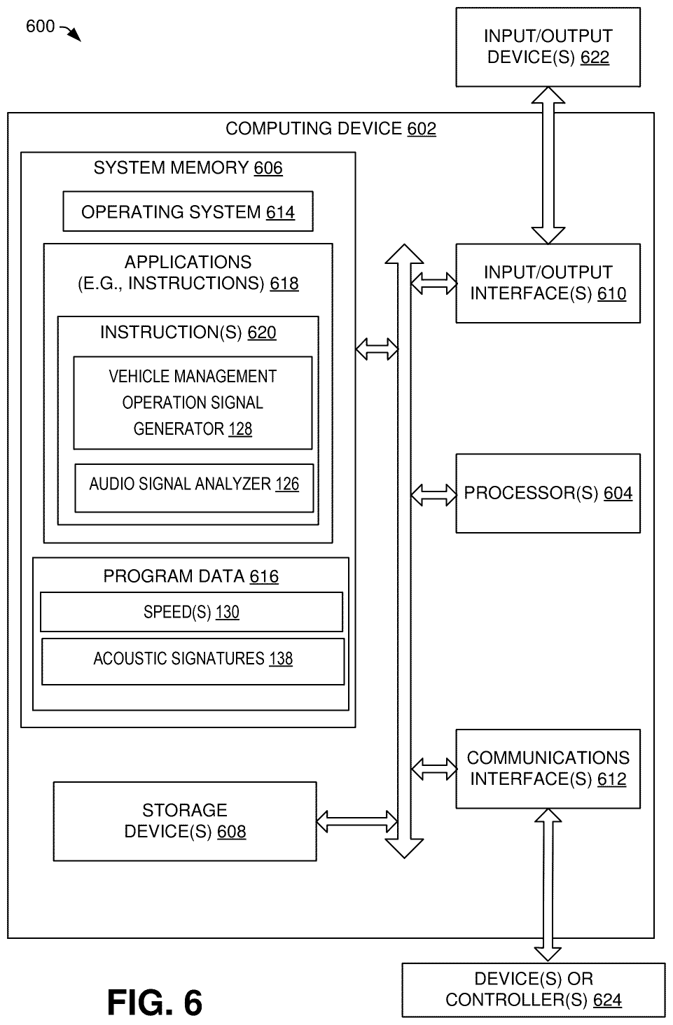

FIG. 3 is a flow chart of an example method 300 for using a vehicle acoustic signature to determine a speed associated with a vehicle, in accordance with some examples of the subject disclosure. The method 300 can be initiated, performed, or controlled by one or more processors executing instructions, such as by the processor(s) 122 of FIG. 1, the processor(s) 604 of FIG. 6 executing instructions 620 from the system memory 606, or a combination thereof.

In some implementations, the method 300 includes, at block 302, receiving, at a computing device, from a first microphone positioned in an interior of a vehicle, an audio signal corresponding to sound received by the first microphone. The sound is generated by movement of a first surface of the vehicle relative to a fluid. For example, the computing device 104 of FIG. 1 receives, from the first microphone 114A positioned in the interior 112 of the vehicle 102, the audio signal 120 corresponding to the first sound 116A received by the first microphone 114A.

The method 300 includes, at block 304, analyzing, by the computing device, the audio signal to determine a first speed associated with the vehicle based on an acoustic signature associated with the first surface. For example, the computing device 104 of FIG. 1 analyzes the audio signal 120 to determine the first speed 130A associated with the vehicle 102 based on the acoustic signatures 138 associated with the first surface 118A.

The method 300 also includes, at block 306, causing, by the computing device, based at least on the first speed of the vehicle, performance of one or more vehicle management operations. For example, the computing device 104 of FIG. 1 can be configured to cause, based at least on the speed 130A of the vehicle 102, performance of one or more vehicle management operations at least by communicating one or more vehicle management operation signals 144 to the vehicle 102.

In some implementations, the method 300 can include more, fewer, and/or different steps without departing from the scope of the subject disclosure. For example, the method 300 can also include receiving, at the computing device 104, from a second microphone 114B positioned in the interior of the vehicle 102 and configured to receive second sound 116B generated by a second surface 118B of the vehicle 102, a second audio signal 120. The method 300 can also include analyzing, by the computing device 104, the second audio signal of the audio signals 120 to determine a second speed 130B of the vehicle based on the second signal of the audio signals 120 and acoustic signatures 138 associated with the second surface 118B.

Further, the methods described above with reference to FIG. 3 can be implemented to realize one or more of the technical advantages described in more detail above. For example, the method 300 can enable a more reliable and maintainable speed sensor operable in a different environment than certain traditional speed sensors (e.g., the interior of an aircraft as opposed to the exterior of the aircraft).

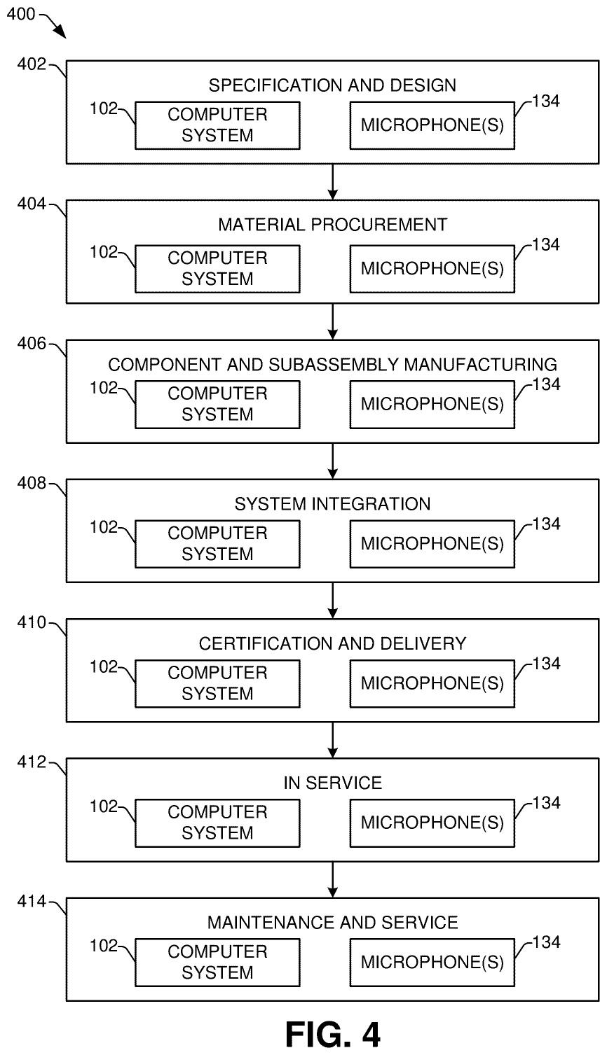

FIG. 4 is a flowchart of an example method 400 illustrating a life cycle of an aircraft that includes a system for using an acoustic signature to determine a speed associated with the aircraft, in accordance with some examples of the subject disclosure. During pre-production, the method 400 includes, at 402, specification and design of the aircraft. During specification and design of the aircraft, the method 400 may include specification and design of the computing device 104 of FIG. 1; and specification, location, and design of the microphone(s) 114. The computing device 104 may be included in a flight control computer of the aircraft. At 404, the method 400 includes material procurement, which may include procuring materials for the computing device 104.

During production, the method 400 includes, at 406, component and subassembly manufacturing and, at 408, system integration of the aircraft. For example, the method 400 may include component and subassembly manufacturing of the computing device 104 and microphone(s) 114 and system integration of the computing device 104 and microphone(s) 114. At 410, the method 400 includes certification and delivery of the aircraft and, at 412, placing the aircraft in service. Certification and delivery may include certification of the computing device 104 and microphone(s) 114 to place the computing device 104 in service. While in service by a customer, the aircraft may be scheduled for routine maintenance and service (which may also include modification, reconfiguration, refurbishment, component replacement, and so on). At 414, the method 400 includes performing maintenance and service on the aircraft, which may include performing maintenance and service on the computing device 104 and microphone(s) 114.

Each of the processes of the method 400 may be performed or carried out by a system integrator, a third party, and/or an operator (e.g., a customer). For the purposes of this description, a system integrator may include without limitation any number of aircraft manufacturers and major-system subcontractors; a third party may include without limitation any number of venders, subcontractors, and suppliers; and an operator may be an airline, leasing company, military entity, service organization, and so on.

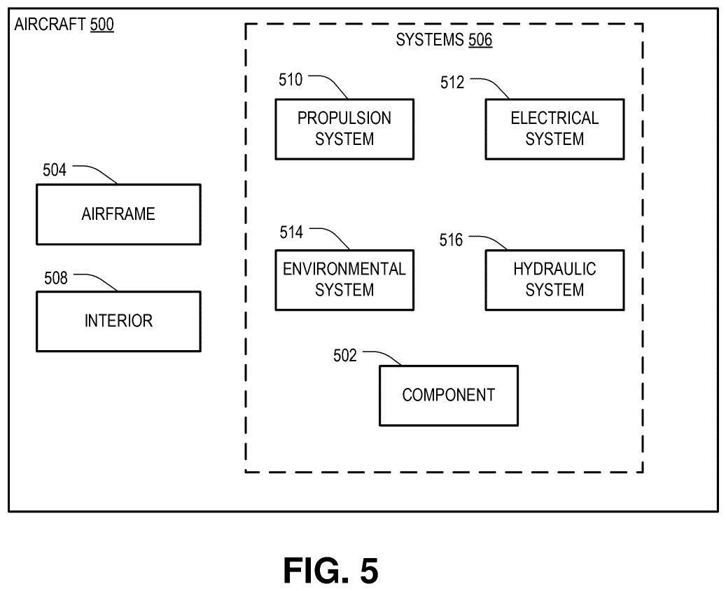

FIG. 5 illustrates an example aircraft 500 that includes a speed sensor 502 that uses an acoustic signature associated with a surface of the aircraft 500 to determine a speed associated with the aircraft 500, in accordance with some examples of the subject disclosure (e.g., using the method 300 of FIG. 3). In the example of FIG. 5, the aircraft 500 includes an airframe 504 with a plurality of systems 506 and an interior 508. Examples of the plurality of systems 506 include one or more of a propulsion system 510, an electrical system 512, an environmental system 514, and a hydraulic system 516. Any number of other systems may be included.

In the example of FIG. 5, the speed sensor 502 includes the computing device 104 and microphone(s) 114 of FIG. 1. In some implementations, the speed sensor 502 is configured to perform certain operations, such as those described above with reference to the method 300 of FIG. 3.

To illustrate, in some examples, the speed sensor 502 is included in the airframe 504. In one example, the microphone(s) 114 of the speed sensor 502 receives sound(s) 116 generated by first surface(s) 118 of the aircraft 500 due to relative motion of the aircraft 500 to air. Alternatively or in addition, in other examples, the speed sensor 502 includes or corresponds to another component of the aircraft 500, such as wiring, components of the interior 508 that include the computing device 104, the microphone(s) 114, and support structure for speed sensor 502.

FIG. 6 is a block diagram of a computing environment 600 including a computing device 602 configured to support aspects of computer-implemented methods and computer-executable program instructions (or code), in accordance with some examples of the subject disclosure. For example, the computing device 602, or portions thereof, is configured to execute instructions to initiate, perform, or control one or more operations described in more detail above with reference to FIGS. 1-5. In a particular aspect, the computing device 602 can include, correspond to, or be included within a computing device, one or more servers, one or more virtual devices, or a combination thereof.

The computing device 602 includes one or more processors 604. The processor(s) 604 are configured to communicate with system memory 606, one or more storage devices 608, one or more input/output interfaces 610, one or more communications interfaces 612, or any combination thereof. The system memory 606 includes volatile memory devices (e.g., random access memory (RAM) devices), nonvolatile memory devices (e.g., read-only memory (ROM) devices, programmable read-only memory, and flash memory), or both. The system memory 606 stores an operating system 614, which can include a basic input/output system for booting the computing device 602 as well as a full operating system to enable the computing device 602 to interact with users, other programs, and other devices. The system memory 606 stores system (program) data 616, such as the speed(s) 130 of FIG. 1, the acoustic signatures 138 associated with particular surfaces 118 of the vehicle 102, or a combination thereof.

The system memory 606 includes one or more applications 618 (e.g., sets of instructions) executable by the processor(s) 604, such as the vehicle management operation signal generator 128 of FIG. 1, the audio signal analyzer 126, or a combination thereof. As an example, the one or more applications 618 include the instructions 620 executable by the processor(s) 604 to initiate, control, or perform one or more operations described with reference to FIGS. 1-5. To illustrate, the one or more applications 618 include the instructions 620 executable by the processor(s) 604 to initiate, control, or perform one or more operations described with reference to receiving the audio signal(s) 120 of FIG. 1, analyzing the audio signal(s) 120 to determine the speed(s) 130, and causing performance of one or more vehicle management operations.

In a particular implementation, the system memory 606 includes a non-transitory, computer readable medium (e.g., a computer-readable storage device) storing the instructions 620 that, when executed by the processor(s) 604, cause the processor(s) 604 to initiate, perform, or control operations for using determining vehicle speed based on sound generated by a relative movement of a surface of the vehicle to a fluid. The operations include receiving, from one or more microphones positioned in an interior of the vehicle and configured to receive sound generated by surfaces of the vehicle associated with the microphone(s) passing through a fluid, audio signal(s) associated with the surface(s). The operations also include analyzing the audio signal(s) to determine one or more speeds (i.e., a speed associated with each of the one or more microphones) of the vehicle based on comparisons of features of the audio signals to features of acoustic signatures associated with the surface(s) that correspond to particular speeds of the vehicle. The operations also include, based at least on the speed(s) of the vehicle, causing performance of one or more vehicle management operations. In other examples, the operations can also include, based at least on a side slip measurement, an angle of attack measurement, or a combination thereof, causing performance of one or more vehicle management operations.

The one or more storage devices 608 include nonvolatile (i.e., non-transitory) storage devices, such as magnetic disks, optical disks, or flash memory devices. In a particular example, the storage devices 608 include both removable and non-removable memory devices. The storage devices 608 are configured to store an operating system, images of operating systems, applications (e.g., one or more of the applications 618), and program data (e.g., the program data 616). In a particular aspect, the system memory 606, the storage devices 608, or both, include tangible (i.e., non-transitory) computer-readable media. In a particular aspect, one or more of the storage devices 608 are external to the computing device 602.

The one or more input/output interfaces 610 enable the computing device 602 to communicate with one or more input/output devices 622 to facilitate user interaction. For example, the one or more input/output interfaces 610 can include a display interface, an input interface, or both. For example, the input/output interface 610 is adapted to receive input from a user, to receive input from another computing device, or a combination thereof. In some implementations, the input/output interface 610 conforms to one or more standard interface protocols, including serial interfaces (e.g., universal serial bus (USB) interfaces or Institute of Electrical and Electronics Engineers (IEEE) interface standards), parallel interfaces, display adapters, audio adapters, or custom interfaces (“IEEE” is a registered trademark of The Institute of Electrical and Electronics Engineers, Inc. of Piscataway, New Jersey). In some implementations, the input/output device(s) 622 includes one or more user interface devices and displays, including some combination of buttons, keyboards, pointing devices, displays, speakers, microphones, touch screens, and other devices.

The processor(s) 604 are configured to communicate with devices or controllers 624 via the one or more communications interfaces 612. For example, the one or more communications interfaces 612 can include a network interface. The devices or controllers 624 can include, for example, the vehicle 102 of FIG. 1.

In some implementations, a non-transitory, computer readable medium (e.g., a computer-readable storage device) stores instructions that, when executed by one or more processors, cause the one or more processors to initiate, perform, or control operations to perform part of or all the functionality described above. For example, the instructions can be executable to implement one or more of the operations or methods of FIGS. 1-5. In some implementations, part or all of one or more of the operations or methods of FIGS. 1-5 can be implemented by one or more processors (e.g., one or more central processing units (CPUs), one or more graphics processing units (GPUs), one or more digital signal processors (DSPs)) executing instructions, by dedicated hardware circuitry, or any combination thereof.

The illustrations of the examples described herein are intended to provide a general understanding of the structure of the various implementations. The illustrations are not intended to serve as a complete description of all of the elements and features of apparatus and systems that utilize the structures or methods described herein. Many other implementations can be apparent to those of skill in the art upon reviewing the disclosure. Other implementations can be utilized and derived from the disclosure, such that structural and logical substitutions and changes can be made without departing from the scope of the disclosure. For example, method operations can be performed in a different order than shown in the figures or one or more method operations can be omitted. Accordingly, the disclosure and the figures are to be regarded as illustrative rather than restrictive.

Moreover, although specific examples have been illustrated and described herein, it should be appreciated that any subsequent arrangement designed to achieve the same or similar results can be substituted for the specific implementations shown. This disclosure is intended to cover any and all subsequent adaptations or variations of various implementations. Combinations of the above implementations, and other implementations not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features can be grouped together or described in a single implementation for the purpose of streamlining the disclosure. Examples described above illustrate but do not limit the disclosure. It should also be understood that numerous modifications and variations are possible in accordance with the principles of the subject disclosure. As the following claims reflect, the claimed subject matter can be directed to less than all of the features of any of the disclosed examples. Accordingly, the scope of the disclosure is defined by the following claims and their equivalents.

Further, the disclosure comprises embodiments according to the following examples:

According to Example 1, a method includes receiving, at a computing device, from a first microphone positioned in an interior of a vehicle, an audio signal corresponding to sound received by the first microphone, wherein the sound is generated by movement of a first surface of the vehicle relative to a fluid; analyzing, by the computing device, the audio signal to determine a first speed associated with the vehicle based on an acoustic signature associated with the first surface; and based at least on the speed of the vehicle, causing, by the computing device, performance of one or more vehicle management operations.

Example 2 includes the method of Example 1, wherein analyzing the audio signal comprises transforming the audio signal to a frequency domain signal.

Example 3 includes the method of Example 1 or Example 2, wherein transforming the audio signal to the frequency domain signal comprises applying, by a processor, a Fourier transform to the audio signal.

Example 4 includes the method of any of Examples 1 to 3, wherein analyzing the audio signal comprises analyzing, by a trained machine learning model, the audio signal to determine the speed.

Example 5 includes the method of Example 4, wherein the trained machine learning model is trained using data associated with a frequency domain transformation of a training data audio signal.

Example 6 includes the method of Example 4 or Example 5, wherein the trained machine learning model is tested using data associated with a frequency domain transformation of a training data audio signal.

Example 7 includes the method of any of Examples 4 to 6, wherein the trained machine learning model is trained using training data with values of the first speed determined by a sensor of the vehicle.

Example 8 includes the method of any of Examples 1 to 7, wherein said analyzing the audio signal includes: obtaining information associated with a plurality of frequencies of the audio signal; analyzing a frequency intensity level associated with each of the plurality of frequencies; and based at least on the frequency intensity levels associated with each of the plurality of frequencies, determining the speed of the vehicle.

Example 9 includes the method of any of Examples 1 to 8, wherein the vehicle comprises a land vehicle, a water vehicle, an aircraft, or a combination thereof.

Example 10 includes the method of any of Examples 1 to 9, wherein the vehicle management operations comprise: generating an excessive speed alert signal; generating an insufficient speed alert signal; altering the speed of the vehicle; or some combination thereof.

Example 11 includes the method of any of Examples 1 to 10, and further includes: receiving a second audio signal corresponding to second sound from a second microphone positioned in the interior of the vehicle, wherein the second microphone is configured to receive second sound generated by movement of a second surface of the body relative to the fluid; and analyzing the second audio signal to determine a second speed associated with the vehicle based on a second acoustic signature of the second surface

Example 12 includes the method of Example 11, wherein: the first surface is located on a first side of the vehicle; the second surface is located on a second side of the vehicle opposite to the first side; and the method further includes determining, by the computing device, a side slip measurement of the vehicle based on the speed and the second speed.

Example 13 includes the method of Example 12, wherein the vehicle management operations comprise generating a side slip alert signal when the side slip measurement exceeds a threshold.

Example 14 includes the method of any of Examples 11 to 13, wherein: the first surface is located on a bottom of the vehicle; the second surface is located on a top of the vehicle opposite the bottom; and the method further includes determining, by the computing device, an angle of attack measurement based on the speed and the second speed.

Example 15 includes the method of any of Examples 1 to 14, wherein the acoustic signature is based at least on a position on the vehicle, a skin friction associated with the portion, a shape of the portion, or a combination thereof.

According to Example 16, a non-transitory computer-readable medium includes instructions that, when executed by one or more processors, cause the one or more processors to: receive, from a first microphone positioned in an interior of a vehicle, an audio signal corresponding to sound received by the first microphone, wherein the sound is generated by movement of a first surface of the vehicle relative to a fluid; analyze the audio signal to determine a speed associated with the vehicle based on an acoustic signature associated with the first surface; and based at least on the speed of the vehicle, cause performance of one or more vehicle management operations.

Example 17 includes the non-transitory, computer-readable medium of Example 16, wherein the instructions, when executed by the one or more processors, cause the one or more processors to transform the audio signal to a frequency domain signal.

Example 18 includes the non-transitory, computer-readable medium of Example 17, wherein the instructions, when executed by the one or more processors, cause the one or more processors to transform the audio signal to the frequency domain signal by application of a Fourier transform to the audio signal.

Example 19 includes the non-transitory, computer-readable medium of Example 17 or Example 18, wherein the instructions, when executed by the one or more processors, cause the one or more processors to analyze the audio signal by provision of the audio signal to a trained machine learning model that determines the speed.

Example 20 includes the non-transitory, computer-readable medium of any of Examples 18 to 20, wherein the trained machine learning model is trained using data with a frequency domain transformation of a training data audio signal.

Example 21 includes the non-transitory, computer-readable medium of Example 19 or Example 20, wherein the trained machine learning model is tested using data with a frequency domain transformation of a testing data audio signal.

Example 22 includes the non-transitory, computer-readable medium of any of Examples 19 to 21, wherein the trained machine learning model is trained using training data with values of the first speed determined by a sensor of the vehicle.

Example 23 includes the non-transitory, computer-readable medium of any of Examples 16 to 22, wherein the instructions, when executed by the one or more processors, cause the one or more processors to analyze the audio signal, wherein said analyze the audio signal includes: obtain information associated with a plurality of frequencies of the audio signal; analyze a frequency intensity level associated with each of the plurality of frequencies; and based at least on the frequency intensity levels associated with each of the plurality of frequencies, determine the first speed.

Example 24 includes the non-transitory, computer-readable medium of any of Examples 16 to 23, wherein the vehicle comprises a land vehicle, a water vehicle, an aircraft, a spacecraft, or a combination thereof.

Example 25 includes the non-transitory, computer-readable medium of any of Examples 16 to 24, wherein the vehicle management operations comprise generation of an excessive speed alert signal, generation of an insufficient speed alert signal, alteration of the speed of the vehicle, or some combination thereof.

Example 26 includes the non-transitory, computer-readable medium of any of Examples 16 to 25, wherein the instructions, when executed by the one or more processors, further cause the one or more processors to: receive a second audio signal corresponding to second sound from a second microphone positioned in the interior of the vehicle, wherein the second microphone is configured to receive second sound generated by movement of a second surface of the body relative to the fluid; and analyze the second audio signal to determine a second speed associated with the vehicle based on a second acoustic signature of the second surface.

Example 27 includes the non-transitory, computer-readable medium of Example 26, wherein: the first surface is located on a first side of the vehicle; the second surface is located on a second side of the vehicle opposite to the first side; and the one or more processors are further configured to determine a side slip measurement of the vehicle based on the speed and the second speed.

Example 28 includes the non-transitory, computer-readable medium of Example 27, wherein the vehicle management operations comprise generation of a side slip alert signal when the side slip measurement exceeds a threshold.

Example 29 includes the non-transitory, computer-readable medium of any of Examples 26 to 28, wherein: the first surface is located on a bottom of the vehicle; the second surface is located on a top of the vehicle opposite the bottom; and the one or more processors are further configured to determine an angle of attack measurement based on the speed and the second speed.

Example 30 includes the non-transitory, computer-readable medium of any of Examples 16 to 29, wherein the acoustic signature is based at least on a location of the first surface on the vehicle, skin friction associated with the first surface, a shape of the first surface, or a combination thereof.

According to Example 31, a vehicle includes a body; a first microphone positioned in an interior of the body and configured to receive sound generated by movement of a first surface of the body relative to a fluid; and one or more processors coupled to the first microphone, wherein the one or more processors are configured to: receive an audio signal corresponding to sound received by the first microphone; analyze the audio signal to determine a first speed associated with the vehicle based on an acoustic signature associated with the first surface; and based at least on the speed of the vehicle, cause performance of one or more vehicle management operations.

Example 32 includes the vehicle of Example 31, wherein the one or more processors are further configured to transform the audio signal to a frequency domain signal.

Example 33 includes the vehicle of Example 32, wherein the one or more processors transform the audio signal to the frequency domain signal by application of a Fourier transform to the audio signal.

Example 34 includes the vehicle of Example 32 or Example 33, wherein said analyze the audio signal provides the audio signal to a trained machine learning model (136) that determines the first speed.

Example 35 includes the vehicle of Example 34, wherein the trained machine learning model is trained using data with a frequency domain transformation of a training data audio signal.

Example 36 includes the vehicle of Example 34 or Example 35, wherein the trained machine learning model is tested using data with a frequency domain transformation of a testing data audio signal.

Example 37 includes the vehicle of any of Examples 34 to 36, wherein the trained machine learning model is trained using training data with values of the first speed determined by a sensor of the vehicle.

Example 38 includes the vehicle of any of Examples 31 to 37, wherein said analyze the audio signal includes: obtain information associated with a plurality of frequencies of the audio signal; analyze a frequency intensity level associated with each of the plurality of frequencies; and based at least on the frequency intensity levels associated with each of the plurality of frequencies, determine the first speed.

Example 39 includes the vehicle of any of Examples 31 to 38, wherein the vehicle comprises a land vehicle, a water vehicle, an aircraft, or a combination thereof.

Example 40 includes the vehicle of any of Examples 31 to 39, wherein the vehicle management operations comprise generation of an excessive speed alert signal, generation of an insufficient speed alert signal, alteration of the speed of the vehicle, or some combination thereof.

Example 41 includes the vehicle of any of Examples 31 to 40, wherein the one or more processors are further configured to: receive a second audio signal corresponding to second sound from a second microphone positioned in the interior of the vehicle, wherein the second microphone is configured to receive second sound generated by movement of a second surface of the body relative to the fluid; and analyze the second audio signal to determine a second speed associated with the vehicle based on a second acoustic signature of the second surface.

Example 42 includes the vehicle of Example 41, wherein: the first surface is located on a first side of the vehicle; the second surface is located on a second side of the vehicle opposite to the first side; and the one or more processors are further configured to determine a side slip measurement of the vehicle based on the speed and the second speed.

Example 43 includes the vehicle of Example 42, wherein the vehicle management operations comprise generation of a side slip alert signal when the side slip measurement exceeds a threshold.

Example 44 includes the vehicle of any of Examples 41 to 43, wherein: the first surface is located on a bottom of the vehicle; the second surface is located on a top of the vehicle opposite the bottom; and the one or more processors are further configured to determine an angle of attack measurement based on the speed and the second speed.

Example 45 includes the vehicle of any of Examples 31 to 44, wherein the acoustic signature is based at least on a location of the first surface on the vehicle, skin friction associated with the first surface, a shape of the first surface, or a combination thereof.

What is claimed is:

1. A vehicle comprising:
a body;
a first microphone positioned in an interior of the body and configured to receive sound generated by movement of a first surface of the body relative to a fluid; and
one or more processors coupled to the first microphone, wherein the one or more processors are configured to:
receive an audio signal corresponding to sound received by the first microphone;
analyze the audio signal to determine a first speed associated with the vehicle based on an acoustic signature associated with the first surface; and
based at least on the first speed, cause performance of one or more vehicle management operations.

2. The vehicle of claim 1, wherein the one or more processors are further configured to transform the audio signal to a frequency domain signal.

3. The vehicle of claim 2, wherein the one or more processors transform the audio signal to the frequency domain signal by application of a Fourier transform to the audio signal.

4. The vehicle of claim 1, wherein said analyze the audio signal provides the audio signal to a trained machine learning model that determines the first speed.

5. The vehicle of claim 4, wherein the trained machine learning model is trained using training data associated with frequency domain transformations of a training data audio signal.

6. The vehicle of claim 4, wherein the trained machine learning model is tested using testing data associated with frequency domain transformations of a testing data audio signal.

7. The vehicle of claim 4, wherein the trained machine learning model is trained using training data with values of the first speed determined by a sensor of the vehicle.

8. The vehicle of claim 1, wherein said analyze the audio signal includes:
obtain information associated with a plurality of frequencies of the audio signal;
analyze a frequency intensity level associated with each of the plurality of frequencies; and
based at least on the frequency intensity levels associated with each of the plurality of frequencies, determine the first speed.

9. The vehicle of claim 1, wherein the vehicle comprises a land vehicle, a water vehicle, an aircraft, a spacecraft, or a combination thereof.

10. The vehicle of claim 1, wherein the one or more vehicle management operations comprise display of an indication of the first speed, generation of an excessive speed alert signal, generation of an insufficient speed alert signal, alteration of the first speed, or some combination thereof.

11. The vehicle of claim 1, wherein the one or more processors are further configured to:
receive a second audio signal corresponding to second sound from a second microphone positioned in the interior of the vehicle, wherein the second microphone is configured to receive second sound generated by movement of a second surface of the body relative to the fluid; and
analyze the second audio signal to determine a second speed associated with the vehicle based on a second acoustic signature of the second surface.

12. The vehicle of claim 11, wherein:
the first surface is located on a first side of the vehicle;
the second surface is located on a second side of the vehicle opposite to the first side; and
the one or more processors are further configured to determine a side slip measurement of the vehicle based on the first speed and the second speed.

13. The vehicle of claim 12, wherein the vehicle management operations comprise generating a side slip alert signal when the side slip measurement exceeds a threshold.

14. The vehicle of claim 11, wherein:
the first surface is located on a bottom of the vehicle;
the second surface is located on a top of the vehicle opposite the bottom; and
the one or more processors are further configured to determine an angle of attack measurement based on the first speed and the second speed.

15. The vehicle of claim 1, wherein the acoustic signature is based at least on a location of the first surface on the vehicle, skin friction associated with the first surface, a shape of the first surface, or a combination thereof.

16. A method comprising:
receiving, at a computing device, from a first microphone positioned in an interior of a vehicle, an audio signal corresponding to sound received by the first microphone, wherein the sound is generated by movement of a first surface of the vehicle relative to a fluid;
analyzing, by the computing device, the audio signal to determine a first speed associated with the vehicle based on an acoustic signature associated with the first surface; and
based at least on the first speed, causing, by the computing device, performance of one or more vehicle management operations.

17. The method of claim 16, wherein said analyzing the audio signal comprises:
obtaining information associated with a plurality of frequencies of the audio signal;
analyzing a frequency intensity level associated with each of the plurality of frequencies; and
based at least on the frequency intensity levels associated with each of the plurality of frequencies, determining the first speed of the vehicle.

18. The method of claim 16, further comprising:
receiving, at the computing device, from a second microphone positioned in the interior of the vehicle and configured to receive second sound generated by movement of a second surface of the vehicle relative to the fluid, a second audio signal associated with a second acoustic signature of the second surface; and
analyzing, by the computing device, the second audio signal to determine a second speed associated with the vehicle.

19. The method of claim 18, wherein:
the first surface is located on a first side of the vehicle;
the second surface is located on a second side of the vehicle opposite to the first side;
the method further comprises determining, by the computing device, a side slip measurement of the vehicle based on the first speed and the second speed; and
the vehicle management operations comprise generating a side slip alert signal when the side slip measurement exceeds a threshold.

20. A non-transitory computer-readable medium comprising instructions that, when executed by one or more processors, cause the one or more processors to:
receive, from a first microphone positioned in an interior of a vehicle an audio signal corresponding to sound received by the first microphone, wherein the sound is generated by movement of a first surface of the vehicle relative to a fluid;
analyze the audio signal to determine a speed of the vehicle associated with the vehicle based on an acoustic signature associated with the first surface; and
based at least on the speed of the vehicle, cause performance of one or more vehicle management operations.
